(19) United States
(12) Patent Application Publication
(10) Pub. No.: US 2012/0208083 A1
(43) Pub. Date: Aug. 16, 2012

(54) Silicon Based Electrode Formulations for Lithium-ion Batteries and Method for Obtaining It

(76) Inventors: Mohamed Ati, Amiens (FR); Jean Scoyer, Herentals (BE); Stijn Put, Olmen (BE); Kris Driesen, Hasselt (BE)

(21) Appl. No.: 13/394,863

(22) PCT Filed: Sep. 20, 2010
(86) PCT No.: PCT/EP10/05748

§ 371 Date: Apr. 27, 2012

Related U.S. Application Data
(60) Provisional application No. 61/277,299, filed on Sep. 23, 2009.

(51) Int. Cl. H01M 4/48; H01M 4/62; H01M 4/38; B05D 5/12; H01M 4/64; H01M 4/60; B82Y 40/00; B82Y 30/00

(52) U.S. Cl. 429/211; 427/58; 977/775; 977/892

(57) ABSTRACT

An electrode assembly for a rechargeable Li-ion battery, comprising a current collector provided with an electrode composition comprising carboxymethyl cellulose (CMC) binder material and silicon powder provided with a layer of SiO₂ or silicon suboxides SiOₓ, with 0<x≦2, such that the oxygen content of said silicon is between 3 and 18% by weight.

This invention pertains to new electrode formulations for lithium-ion batteries. Today, lithium-ion batteries are widely used in portable electronic devices. Compared to other rechargeable cells, such as nickel-cadmium and nickel metal hydride, Li-ion cells have higher energy density, higher operating voltages, lower self discharge, and low maintenance requirements. These properties have made Li-ion cells the highest performing available secondary battery.

The worldwide energy demand increase has driven the lithium-ion battery community to search for new generation electrode materials with high energy density. One of the approaches is to replace the conventional carbon graphite negative electrode material by metal or metallic alloy based on for example silicon (Si), tin (Sn) and/or aluminum (Al). These materials can provide much higher specific and volumetric capacities than graphite.

Electrodes for Li-ion batteries are commonly prepared with standard formulations and routine processing conditions. More and more studies report the impact of formulations, morphology, and processing routines on the electrochemical performance of composite electrode. However, formulations and processing of the composite electrodes are strongly influenced by the experimental and technical parameters such as the physical and chemical properties of materials, mixing sequences of material sources, time, temperature, electrodes thickness, . . . . These parameters should be optimized to enhance the composite electrode stability and its electrochemical performances.

Different polymers have been studied as binders' additives for negative/positive composite electrodes and as electrolytes host for lithium-ion batteries. One of the most studied polymers is Poly-(ethylene oxide). However, this polymer has some limitations such as its relatively high operating temperature (−80° C.) and its electrochemical instability above 4 V vs Li⁺/Li.

Consequently, polymers with high electrochemical stability such as PTFE, PVdF, and PVdF-HFP copolymer have been widely adopted as a binder for composite electrodes in lithium-ion batteries. Remarkable improvement resulted from the use of the PVdF-HFP copolymer in PLIon™ technology. This copolymer has a good distribution of amorphous and crystalline domains which allows a high uptake of liquid electrolyte and provides good mechanical cohesion. However, due to poor chemical properties (bonding effects), environmental issues, and safety aspects with new negative electrode materials these binders are substituted by new binder types such as silica, gelatin, poly-(acrylonitrile-methyl methacrylate) (PAMMA), poly-(methyl methacrylate) (PMMA), polypyrrole, aromatic polyamides, carboxymethyl cellulose (CMC), and styrene butadiene rubber (SBR). Since safety, cost and environmental issues arise daily, a switch away from organic process using organic solvents became an obligation. Recently, many attempts have been made to switch from non-aqueous to aqueous processes.

Si-based negative electrode materials could significantly enhance the energy density of the commercial lithium ion batteries. Silicon has the largest theoretical gravimetric capacity (3579 mAh/g) corresponding to the following reaction: 15Li+4Si→Li₁₅Si₄ and a large volumetric capacity (2200 mAh/cm³). Unfortunately, it exhibits poor capacity retention. This poor cycle life is also due to the huge volume expansion (+310%) over cycling, as the particles break up and become non-contacted. Several studies have been made to reduce the capacity fading of Si-based electrodes. Nevertheless, the binder has been found to play a key role in stabilizing capacity retention of Si based electrodes. Chen et al. (in: Z. Chen, L. Christensen, and J. R. Dahn; Journal of Electrochemical Society; (150) 1073, 2003) suggested that cycling stability of Si-based electrodes might benefit from the use of elastic binder materials. An elastomeric binder has generally a higher elasticity modulus than PVdF. This allows the composite electrode to expand and shrink more easily and reduces the forces exerted between particles. Li et al. (in: J. Li, R. B. Lewis, and J. R. Dahn; Electrochemical Solid State Letters; (10); 17 (2007)) showed that Si-based electrodes using Na-CMC as binder experienced good cycling performance although Na-CMC is not elastomeric and has a low elongation to break.

It is an aim of the present invention to further improve the performance of the electrode compositions used in lithium-ion batteries.

Viewed from a first aspect, the present invention can provide an electrode assembly comprising a current collector provided with an electrode composition comprising carboxymethyl cellulose (CMC) binder material and silicon powder provided with a layer of SiO₂ or silicon suboxides SiOₓ, with 0<x≦2, such that the oxygen content of said silicon is between 3 and 18% by weight. In one embodiment the electrode composition can have a capacity of more than 2600 mAh/g silicon, when cycled between 0.01 and 1.0V. In another embodiment this capacity can be achieved at the 5^{th} charge.

In a further embodiment the oxygen content of the silicon powder can be between 3 and 10% by weight, for 1≦x≦2. In one embodiment the electrode composition can have a capacity of more than 3300 mAh/g silicon, when cycled between 0.01 and 1.0V. In another embodiment this capacity is achieved at the 5^{th} charge. In still a further embodiment, the invention can provide an electrode composition having a capacity of more than 520 mAh/g. In one embodiment the electrode composition has a capacity of more than 660 mAh/g.

In another embodiment the silicon powder can have an average particle size of between 0.01 and 1 μm. Here, the average particle size (dₐᵥ) is defined as the average spherical particle size calculated from the specific surface area, assuming spherical particles of equal size, according to the following formula:

$${d}_{av} = \frac{6}{ρ \times BET} ,$$

in which ρ refers to the theoretical density of the powder and BET refers to the specific surface area (m²/g) as determined by the N₂ adsorption method of Brunauer-Emmett-Teller. Particles larger than 1 μm are not preferred since Li-ion diffusion will be too slow and the volume expansion of these particles will be too large. For particles smaller than 10 nm, specific surface area and thus reactivity with the electrolyte will be too high causing fast electrolyte degradation.

In one embodiment the electrode further comprises styrene butadiene rubber as binder material. In another embodiment the electrode composition consists of 20-80 wt % silicon or silicon alloy, 5-40 wt % binder material, the remainder being a compound consisting of carbon. This allows to maintain electrical contacts between the electrode particles during charge/discharge, and to avoid excessive swelling. In yet a further embodiment the electrode composition consists of 20-60 wt % silicon or silicon alloy, 20-40 wt % binder material, and at least 3 wt % of a compound consisting of carbon. In one embodiment the carbon compound consists of acetylene black powder. In another embodiment the electrode consists of 50 wt % silicon, 25 wt % binder material, and 25 wt % acetylene black powder. To avoid continuous deep cycling of the silicon to its full theoretical capacity the voltage of the negative electrode versus lithium can be limited to e.g. 70 mV. To compensate this the silicon content in the electrode can be increased and/or the oxygen content for silicon can be lowered.

Viewed from a second aspect, the invention can also provide a process for preparing the electrode assembly described before, comprising the steps of
dissolving a CMC salt in water so as to obtain an aqueous solution of binder material, and either:
adding the silicon powder first to the CMC solution and thereafter the carbon compound,
or adding the carbon compound first to the CMC solution and thereafter the silicon powder. In both cases a slurry is obtained. The steps thereafter are:
spreading said slurry on a current collector, such as a copper foil, and
curing said electrode assembly comprising said slurry at a temperature between 125 and 175° C.

In both alternative preparation methods the silicon and/or carbon are better dispersed than when mixed together in one step. In one embodiment in both alternative preparation methods aqueous solution of binder material can be aged under stirring for at least 5 hours, before dispersing the silicon powder or the carbon compound. Aging the solution is an example step to complete the dissolution of the CMC salt.

In one embodiment the binder is Na-CMC and the aqueous solution of binder material has a concentration of 2-10 wt % of Na-CMC. In another embodiment the concentration is 2-4 wt %.

In some applications a higher or controlled oxygen content is interesting to shield or protect the silicon particles from side reactions with components in the battery like the electrolyte. Possible ways to increase oxygen contents of silicon nanoparticles include chemical ageing, oxidation in aqueous media, . . . . One example way to vary the oxygen content of the silicon particle in a controlled way is by adapting the pH value of the solution of the CMC salt, and in one embodiment after the aging of the solution. This can be done by adding acids, such as formic acid, which can be removed at higher temperatures, when the electrode assembly is cured. In order to obtain oxygen contents between 3 and 18 wt % the pH of the suspension can be controlled between pH 3 and pH 8.

Another example process for preparing the electrode assembly comprises the steps of:
dissolving a CMC salt in water so as to obtain an aqueous solution of binder material,
dispersing said silicon powder in an aqueous solution having a pH between 3 and 8, so as to obtain a silicon suspension,
mixing said aqueous binder solution and said silicon suspension so as to obtain an aqueous CMC-silicon suspension,
dispersing said carbon compound in said CMC-silicon suspension, thereby obtaining a slurry,
spreading said slurry on a current collector, such as a copper foil, and,
curing said electrode assembly comprising said slurry at a temperature between 125 and 175° C.

The invention is further illustrated by the following examples. Table 1 summarizes the silicon based powders used in the different examples.

### EXAMPLE 1

An Na-CMC solution is prepared with a content of 2 wt % Na-CMC, and is aged under stirring for 12 hr. Also a water based suspension is prepared at pH 8 and nano silicon powder, with a specific surface area of 20 m²/g and an oxygen content of 3 wt %, is added. This suspension is ball milled during 15 minutes using a Fritch Pulverisette 6 (Fritsch Germany). In this way the oxygen level is measured and equals 3 wt %.

Subsequently, a paste or slurry is prepared by first adding the silicon suspension to the Na-CMC solution, whereafter acetylene black is added to the obtained mixture. The final paste, having a silicon/CMC/acetylene black ratio of 50/25/25, is finally ball milled for 30 minutes. Coatings with a thickness between 20 and 30 μm are deposited on a copper foil by doctor blade coating. The electrodes are subsequently cured in a vacuum oven at 150° C. for three hours. Finally coin cell type batteries are prepared in a glove box using Li-foil as counter electrode.

Battery tests are performed on the electrodes under following conditions: between 0.01 and 1.0V at C/20 in which C is defined as a capacity of 3572 mAh/g. This results in a capacity of 3370 mAh/g silicon powder at the 5^{th} charge. (see Table 1) This value is an average of 3 coin cells.

### EXAMPLES 2-5

Different water based suspensions are prepared in which the pH is adapted in a controlled way between 3.0 and 5.0 by adding formic acid (HCOOH) (Merck Index, 90%). In each suspension nano silicon powder, with a specific surface area of 20 m²/g and oxygen content of 3 wt %, is added. Four different suspensions are prepared with pH equal to 3, 3.5, 4.5 and 5. These suspension are ball milled during 15 minutes using the Fritch Pulverisette. Oxygen levels of the silicon powders varies from 8 wt % at pH 5 up to 18 wt % at pH 3.

Pastes are prepared at these different pH by adding Na-CMC and acetylene black to the suspension of silicon prepared as described in Example 1. The final paste, having a silicon/CMC/acetylene black ratio of 50/25/25, is ball milled for 30 minutes. Coatings with a thickness between 20 and 30 μm are deposited on a copper foil by doctor blade coating. The electrodes are subsequently dried in a vacuum oven at 150° C. for three hours. Finally coin cell type batteries are prepared in a glove box using Li-foil as counter electrode.

Battery tests are performed under similar conditions as explained in Example 1. Table 1 gives an overview of the resulting capacity at the 5^{th} charge. These values are an average of 3 coin cells. It is shown that high capacity values between 3120 mAh/g and 3550 mAh/g are obtained between pH 3 and pH 5.

### EXAMPLE 6

A water based suspension is prepared by adding acetylene black to an aged water based Na-CMC solution having a pH of 8. This suspension is ball milled during 15 minutes using the Fritch Pulverisette 6. In this way the oxygen level is measured and equals 3 wt %.

Subsequently, a paste is prepared by adding silicon powder to the acetylene black:Na-CMC suspension. The final paste, having a silicon/CMC/acetylene black ratio of 50/25/25, is finally ball milled for 30 minutes. Coatings with a thickness between 20 and 30 μm are deposited on a copper foil by doctor blade coating. The electrodes are subsequently dried in a vacuum oven at 150° C. for three hours. Finally coin cell type batteries are prepared in a glove box using Li-foil as counter electrode.

Battery tests are performed on the electrodes under following conditions: between 0.01 and 1.0V at C/20 in which C is defined as a capacity of 3572 mAh/g. This resulted in a capacity at the 5^{th} charge that is clearly higher than the value obtained in Example 1.

### COUNTER EXAMPLE 7

A silicon suspension is prepared at pH 2.5, leading to an oxygen level of 23 wt %. A paste and coin cells are prepared and battery tests are performed in a similar way as described in Example 1. The resulting capacity at the 5^{th} charge equals 2600 mAh/g. The capacity level is much lower than for lower oxygen contents and this low capacity is unacceptable.

### COUNTER EXAMPLE 8

A water based suspension is prepared by adding silicon powder and acetylene black in one step in a water based Na-CMC solution at pH 8. The final paste, having a silicon/CMC/acetylene black ratio of 50/25/25, is finally ball milled for 30 minutes. Coatings with a thickness between 20 and 30 μm are deposited on a copper foil by doctor blade coating. The electrodes are subsequently dried in a vacuum oven at 150° C. for three hours. Finally coin cell type batteries are prepared in a glove box using Li-foil as counter electrode.

Battery tests are performed on the electrodes under following conditions: between 0.01 and 1.0V at C/20 in which C is defined as a capacity of 3572 mAh/g. This resulted in a low capacity at the 5^{th} charge that is lower than 85% of the capacity obtained in Example 1.

TABLE 1
Capacity of coin cells vs. oxygen content of the silicon
in the electrode composition.

| | Oxygen content | Capacity 5^{th} charge |
|---|---|---|
| Example | (wt %) | (mAh/g silicon) |
| 1 | 3 | 3370 |
| 2 | 8 | 3550 |
| 3 | 10 | 3360 |
| 4 | 15 | 3300 |
| 5 | 18 | 3120 |
| 6 | 3 | 3572 |
| 7 | 23 | 2600 |
| 8 | — | <2600 |

The exemplification set out herein illustrates preferred embodiments of the invention, in one form, and such exemplification is not to be construed as limiting the scope of the invention in any manner.

1-21. (canceled)

22. An electrode assembly for a rechargeable Li-ion battery, comprising a current collector having an electrode composition comprising nano silicon powder and carboxymethyl cellulose (CMC) binder material, wherein said nano silicon powder has a SiOₓ layer, with 0<x<2, such that the oxygen content of said nano silicon powder is between 3 and 18% by weight.

23. The electrode assembly of claim 22, wherein said electrode composition has a capacity of more than 2600 mAh/g silicon when cycled between 0.01 and 1.0 V.

24. The electrode assembly of claim 23, wherein said capacity is achieved at the 5^{th} charge.

25. The electrode assembly of claim 22, wherein 1≦x<2, and wherein the oxygen content of said nano silicon powder is between 3 and 10% by weight.

26. The electrode assembly of claim 25, wherein said electrode composition has a capacity of more than 3300 mAh/g silicon when cycled between 0.01 and 1.0 V.

27. The electrode assembly of claim 26 wherein said capacity is achieved at the 5^{th} charge.

28. The electrode assembly of claim 23, wherein said electrode composition has a capacity of more than 520 mAh/g electrode.

29. The electrode assembly of claim 25, wherein said electrode composition has a capacity of more than 660 mAh/g electrode.

30. The electrode assembly of claim 22, wherein said nano silicon powder has an average particle size of at least 0.01 μm.

31. The electrode assembly of claim 22, wherein said electrode composition further comprises styrene butadiene rubber as a second binder material.

32. The electrode assembly of claim 22, wherein said electrode composition consists of 20-80 wt % nano silicon, 5-40 wt % binder material, the remainder being a compound consisting of carbon.

33. The electrode assembly of claim 32, wherein said electrode composition consists of 20-60 wt % nano silicon, 20-40 wt % binder material, and at least 3 wt % of a compound consisting of carbon.

34. The electrode assembly of claim 32, wherein said carbon compound consists of acetylene black powder.

35. The electrode assembly of claim 33, wherein said carbon compound consists of acetylene black powder.

36. The electrode assembly of claim 34, wherein said electrode composition consists of 50 wt % silicon, 25 wt % binder material, and 25 wt % acetylene black powder.

37. A process for preparing the electrode assembly of claim 32, comprising:
dissolving a CMC salt in water so as to obtain an aqueous solution of binder material,
dispersing a carbon compound in said aqueous solution,
dispersing a nano silicon powder in said aqueous solution, thereby obtaining a slurry,
spreading said slurry on a current collector thereby making an electrode assembly, and
curing said electrode assembly at a temperature between 125 and 175° C.

38. A process for preparing the electrode assembly of claim 32, comprising:
dissolving a CMC salt in water so as to obtain an aqueous solution of binder material,
dispersing a nano silicon powder in an aqueous solution having a pH between 3 and 8, thereby obtaining a silicon suspension,
mixing said aqueous binder solution and said silicon suspension thereby obtaining an aqueous CMC-silicon suspension,
dispersing a carbon compound in said CMC-silicon suspension, thereby obtaining a slurry,
spreading said slurry on a current collector thereby making an electrode assembly, and
curing said electrode assembly at a temperature between 125 and 175° C.

39. The process of claim 37, wherein said aqueous solution of binder material is aged under stirring for at least 5 hours, before dispersing either said nano silicon powder or said carbon compound in said aqueous binder solution.

40. The process of claim 39, wherein after said aging, the pH of said aqueous solution of binder material is adjusted to a value between 3 and 8 before dispersing either said nano silicon powder or said carbon compound in said aqueous binder solution.

41. The process of claim 40, wherein said adjusting of the pH is obtained by the addition of formic acid.

42. The process of claim 37, wherein said CMC salt is Na-CMC, and wherein said aqueous solution of binder material has a concentration of 2-10 wt % of Na-CMC.
